(19) United States
(12) Patent Application Publication
(10) Pub. No.: US 2005/0003842 A1
(43) Pub. Date: Jan. 6, 2005

(54) Network survey in radio telecommunications network

(75) Inventors: Juha T. Harju, Raahe (FI); Risto Martikkala, Oulu (FI); Juha Matturi, Kempele (FI); Mika M. Makinen, Ylivieska (FI); Ilkka Pesonen, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/663,908

(22) Filed: Sep. 17, 2003

(30) Foreign Application Priority Data
Jul. 2, 2003 (FI) 20030998

(51) Int. Cl. H04B 7/005

(52) U.S. Cl. 455/502

(57) ABSTRACT

In a method of performing a network survey for a radio telecommunications network, signals from a location system external to the network are received for determining the location of the network survey device. The network survey device is located at a first location. Signals from a first base station of the network are received at the first location by the means of the network survey device, thereby measuring the synchronization of the first base station relative to a reference time-frame determined from the location system. The network survey device is moved to a second location. Signals from the first base station are received at the second location by the means of a network survey device, thereby measuring the synchronization of the first base station. The results of the measurements are compared with pre-determined network management criteria. Based upon the result of the comparison, the configuration of the network is modified.

### BACKGROUND OF THE INVENTION

1. Field of the Invention

The invention relates in general to performing network survey for a radio telecommunications network.

2. Description of the Related Art

Performing a network survey in a radio telecommunications network refers to carrying out measurements of various characteristics of the network. The characteristics may be signal characteristics, for example a signal strength or bit error rate, or characteristics relating to a specific event, for example, to a call establishment. A network survey provides information for analyzing the performance of the radio telecommunications network. Such information is important, for example, for verifying that a network is working as planned or for planning further investments to a network for increasing system capacity or quality.

Typical signal characteristics to be measured in a network survey may depend on the telecommunication network standard. In a GSM (Global System for Mobile communications) network, a network survey is typically carried out using a test phone, and the following characteristics are studied: GSM quality class values (0-6) and Bit Error Rate BER (0-50%); field strength results (-dBm) of the serving and neighboring cells (if available to the test phone); output power of the test phone when operating in the network; and call establishment and release messages, and other similar messages relating to the protocol layer 3. If the location of the test phone can be measured, for example, by having a GPS (Global Positioning System) receiver attached to the test phone, it may be possible to measure location information in addition to the network characteristics. In a dual band network, which operates on the same area at two different frequency bands, characteristics for both frequency bands are usually measured. In a GSM 900/1800 Dual Band network, for example, Carrier 1 and Carrier 2 are often measured in a network survey.

Positioning is a recently introduced service in radio telecommunications networks. Positioning refers to determining the current location of a mobile station (MS), and it may be carried out using information about the timing of signals that the mobile station receives from base stations of the radio telecommunications network. Precise positioning introduces new requirements to the radio telecommunications network and, consequently, to the network survey.

Positioning methods may be divided into three categories: network based, mobile based and mobile assisted. Network based positioning refers to determining the location of the mobile station based on the signals received from the mobile station; in this case the mobile station is not actively involved in the positioning. Mobile based positioning refers to determining the location in the mobile station based on the signals received from the radio telecommunications network or from an external system, such as from the GPS. Mobile assisted positioning refers to the radio telecommunication network determining the location of the mobile station, but using information sent by the mobile station. This information sent by the mobile station usually refers to information about the timing of the signals received by the mobile station.

As examples of positioning methods, some positioning methods relating to a GSM network are considered next. Uplink Time Difference of Arrival (UTDOA), Enhanced Observed Time Difference (E-OTD) and Assisted GPS (AGPS) are defined in the 3GGP specification TS 03.71. UTDOA is based on time stamping Mobile Station bursts arriving at the surrounding GSM network elements configured for this function. These network elements are called TDOA Location Management Units (LMU). E-OTD is a positioning method developed from the Observed Time Difference (OTD) feature. OTD refers to the time interval observed by a mobile station between the reception of signals (bursts) from two different base stations in the network. AGPS requires the mobile station to be equipped with at least part of the functionality of a GPS receiver. This required part is the GPS sensor.

The E-OTD positioning is slightly different for accurately synchronized and unsynchronized networks. For optimally synchronized networks, only the mobile station is required to measure relative time of arrival of the signals from several base stations. For unsynchronized or less optimally synchronized networks, the signals are also received by a fixed measuring point known as the Location Measurement Unit (LMU). The location of this fixed measuring point is known. The position of the mobile station is determined by deducing the geometrical components of the time delays to a mobile station from the base stations.

The measurements relating to E-OTD are performed by the mobile station without any additional hardware. For OTD measurements synchronization, normal and dummy bursts can be used. When the transmission frames of base stations are not exactly synchronized, the network needs to measure the Real Time Differences (RTD) between them. To obtain accurate triangulation, OTD measurements and, for non-synchronized base stations, RTD measurements are needed for at least three geographically distinct base stations. Based on the measured OTD values, the location of the mobile station can be calculated either in the network or, if all the needed information is available in the mobile station, in the mobile station itself. The term “MS-assisted” applies when the location of the mobile station is calculated in the network, and the term “MS-based” applies when the location of the mobile station is calculated in the mobile station.

The basic idea in AGPS is to establish a GPS reference network (or a wide-area differential GPS network) whose receivers have clear views of the sky and can operate continuously. This reference network is connected with the GSM network. At the request of a mobile-station-based or network-based application, assistance data from the reference network is transmitted to the mobile station to increase performance of the GPS sensor. The assistance data typically contains time, visible satellite list, satellite signal Doppler, and code phase search window for GPS signals. Additional assisted data, such as differential GPS corrections, approximate mobile station location or cell base station location, can be transmitted to improve the location accuracy and decrease acquisition time.

One of the benefits of assistance data can be shown in the following scenario. In the situation where the GPS receiver/sensor in the mobile station does not know its approximate location, it will not be able to determine the visible satellites or estimate the range and Doppler frequency of these satellites. It has to search the entire code phase and frequency spaces to locate the visible satellites. The relative movements between the satellites and receiver make the search even more time-consuming. Therefore, the time-to-first-fix is one important parameter to evaluate the quality of a GPS receiver. For a standalone GPS, this time could be more than 10 minutes. This is undesirable for certain applications, such as for determining location information for emergency calls. By transmitting assistance data over the GSM network, it is possible to reduce the time-to-first-fix of a GPS receiver/sensor to a few seconds.

In AGPS, when the position is calculated at the network, the mobile station needs to have a GPS sensor and the positioning is mobile assisted. When the position is calculated at the mobile station, the mobile stations needs to have a GPS receiver and the positioning is mobile based. When implemented properly, an AGPS method should be able to deduce the sensor start-up time, increase the sensor sensitivity, and consume less handset power than conventional GPS does.

FIG. 1 illustrates, as an example, a schematic view of a GSM network 10 supporting positioning services. The GSM network 10 contains a radio access network 12 and a core network 20. The radio access network 12 has a plurality of base station controllers (BSC) 14. A base station controller 14 may control a plurality of base stations (BS) 16, which are typically connected to a base station controller with a fixed line connection or, for example, with a point-to-point radio or microwave link. A base station controller 14 is responsible for controlling and managing the radio resources in a base station 16. The core network 20 contains Mobile Switching Centers (MSC) 22, a Home Location Register (HLR) 24 and Visitor Location Registers (VLR) 26. FIG. 1 illustrates, as an example, only one BSC, MSC and VLR.

The location services (LSC) architecture is logically implemented in the GSM network 10 through the addition of one network node, the Mobile Location Center (MLC). A MLC can be either a Serving MLC (SMLC) 30a or a Gateway MLC (GMLC) 30b. The SMLC 30a manages the overall coordination and scheduling of resources required to perform positioning of a mobile station. The SMLC 30a also calculates the final location estimate and accuracy. The GMLC 30b is a node, which an external LCS client accesses for obtaining location information about a mobile station. The GMLC 30b obtains the location area of the mobile station from the Home Location Register after proper authentication, and can then obtain information about the location of the mobile station from the serving MCS.

As mentioned above, in many positioning methods there is a need for a location measurement unit (LMU), which is in a fixed, known position in the network. The LMU makes radio measurements to support one or more positioning methods. These measurements fall into one of two categories. The first category is location measurements specific to one MS; these are used to compute the location of this MS. These measurements are relevant, for example, to UTDOA positioning. The second category is assistance measurements specific to all MSs in a certain geographic area. These measurements are relevant, for example, to E-OTD and AGPS positioning. Typically location management units make measurements of either the first category or of the second category. This means that typically LMUs support UTDOA, E-OTD or AGPS.

All location and assistance measurements obtained by an E-OTD or AGPS LMU are supplied to a particular SMLC associated with the LMU. Instructions concerning the timing, the nature and any periodicity of these measurements are either provided by the SMLC or are pre-administered in the LMU. The specification defines two types of LMUs. An LMU of Type A is exclusively accessed over the normal GSM air interface. This means that the Type A LMU is connected over the air interface to a serving base station. A base station controller provides signaling access for the controlling SMLC. FIG. 1 illustrates this with the Type A LMU 32 and BS 16a. The Type A LMU is typically located at a fixed position at a distance from other GSM network elements. A Type B LMU is accessed over the Abis interface from a BSC, which means that the Type B LMU is connected to the BSC. Type B LMU may be a standalone device or integrated to a base station. This is illustrated in FIG. 1 with the Type B LMU 34a, which is located at a fixed position at a distance from other GSM network elements and connected to BSC 14, and with the Type B LMU 34b, which is connected to the base station 16b. Signaling to a Type B LMU is conducted by routing messages through the controlling BSC.

The positioning services, especially positioning services based on observed time differences and synchronization features, require a radio telecommunication network timing to be properly planned and known. The existing network survey tools support measurement of bit error rates, signal level of received signals and statistics relating to test calls, but they generally do not measure characteristics which affect the accuracy of positioning services.

### SUMMARY OF THE INVENTION

According to a first embodiment of the invention there is provided a method of performing a network survey for a radio telecommunications network including two or more base stations. The method includes a receiving step, a locating step, and a moving step. The receiving step receives signals from a location system external to the network for determining the location of the network survey device. The locating step locates the network survey device at a first location and, with the network survey device at the first location, receives signals from a first base station of the network at the first location by a receiving mechanism of the network survey device, thereby measuring the synchronization of the first base station relative to a reference time-frame determined from the location system. The moving step moves the network survey device to a second location and, with the network survey device at the second location, receives signals from the first base station at the second location by a receiving mechanism of a network survey device, thereby measuring the synchronization of the first base station relative to the reference time-frame.

According to a second embodiment of the invention, there is provided a network survey device including a mechanism for receiving signals from base stations, a mechanism for receiving a reference time-frame signal, and a mechanism for measuring the synchronization of base stations relative to the reference time-frame.

According to a third embodiment of the invention, there is provided a network survey device including a receiver for receiving from signals from base stations, a receiver for receiving a reference time-frame signal, and measuring device for measuring the synchronization of base station relative to the reference time-frame.

### BRIEF DESCRIPTION OF THE DRAWINGS

For a better understanding of the present invention and as how the same may be carried into effect, reference will now be made by way of example to the following description and the accompanying drawings in which:

FIG. 1 shows a schematic view of positioning in a GSM network;

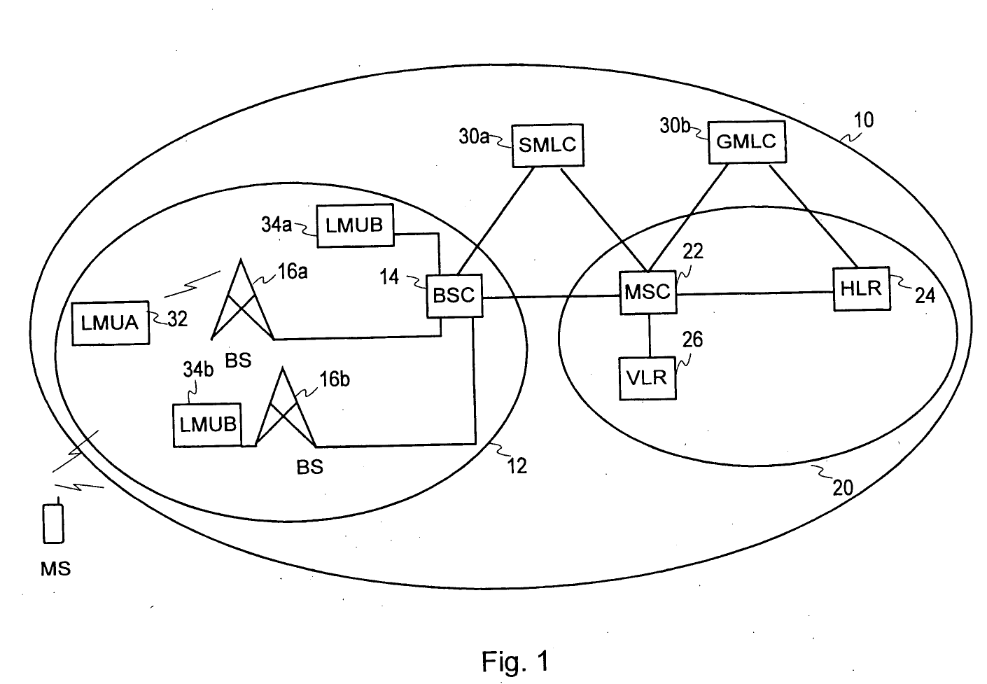

FIG. 2 shows a functional diagram of a network survey device in accordance with a first embodiment of the invention;

FIG. 3 shows an example of using the network survey device in accordance with the first embodiment of the invention; and

FIG. 4 shows a flowchart of a method in accordance with a second embodiment of the invention.

### DETAILED DESCRIPTION OF THE PREFERRED EMBODIMENTS

In the following description relating to the embodiments of the invention, a GSM network is used as an example of a radio telecommunications network and a GSM receiver is used as an example of a mechanism for receiving signals from base stations of a radio telecommunications network. Furthermore, the GPS system is used as an example of an external location system capable of providing a reference time-frame signal and a GPS receiver is used as an example of a mechanism for receiving a reference time-frame signal. It is appreciated that the invention is applicable also in other radio telecommunications networks, such as with the Universal Mobile Telecommunications System (UMTS), and with other external location systems, for example with another satellite location system or with a terrestrial location system.

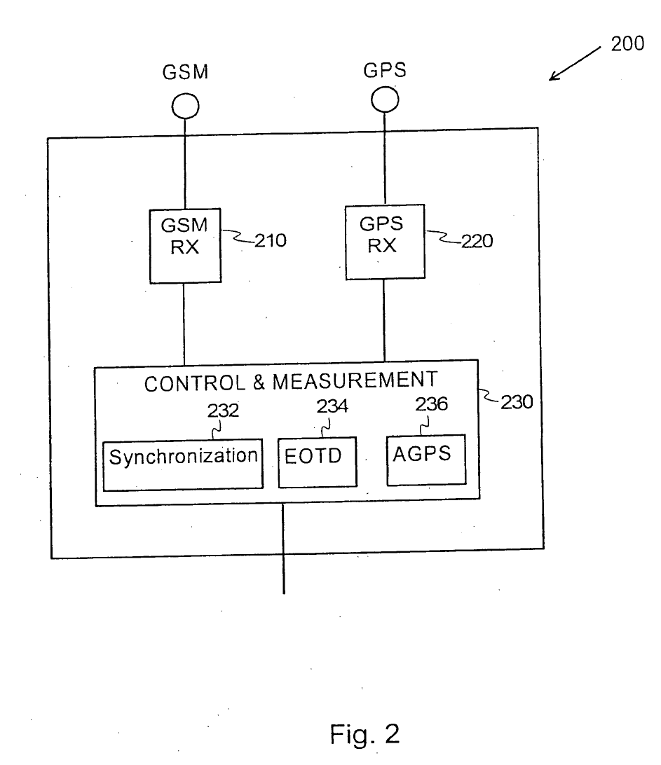

FIG. 2 shows a block diagram of a network survey device 200 in accordance with a first embodiment of the invention. The network survey device 200 contains a GSM receiver 210 and a GPS receiver 220. These are integrated as a single piece of hardware, which is controlled by the control and measurement unit 230. The control and measurement unit 230 thus jointly controls the GSM receiver 210 and the GPS receiver 220.

The network survey device 200 receives signals from base stations with the GSM receiver 210. Preferably the network survey device 200 is able to measure signals from any base station. This is different from the capabilities of a mobile station, which has a SIM (Subscriber Identity Module) card and is able to perform measurements of signals only from those base stations, which belong to a telecommunications network where the subscriber can roam. The GSM receiver 210 of the network survey device 200 may support many frequency bands, such as 800, 900, 1800 and 1900 MHz.

The network survey device 200 receives GPS signals with the GPS receiver 220. The GPS signals provide a reference time frame. By jointly controlling the GSM receiver 210 and the GPS receiver 220 with the control and measurement unit 230, it is possible to measure the synchronization of the base stations relative to the reference time frame. The synchronization is measured by the synchronization block 232, which is part of the network survey device 200. Synchronization block 232 may be used for creating synchronization signals and measuring absolute time accurately.

The network survey device 200 may optionally have measurement blocks adapted for certain positioning methods. FIG. 2 illustrates an E-OTD block 234 and an AGPS block 236. The E-OTD block 234 measures BTS signal Relative Time Difference (RTD) and Reference BTS absolute timing.

The AGPS block 236 measures Signal to Noise-ratio, Elevation and Azimuth for GSP satellites, typically for each satellite from which signals are received. In addition, the AGPS block 236 may determine visibility of the satellites and quality of the signals of the satellites. Visibility here refers to satellites from which GPS signal can be received.

Furthermore, with the help of the GPS receiver 220 it is possible to determine the location of the network survey device 200. The location of the network survey device is typically presented as Latitude, Longitude and Altitude.

The network survey device 200 measures the following characteristics of GSM Broadcast Control Channel (BCCH) signals: RX-level (−dBm), Bit Error Rate (BER) (%), Timing (m/s), and/or Absolute Time. Absolute time here refers to GSM frame number and timeslot compared to a GPS timing signal 1PPS. This timing signal is an analog square pulse, whose leading edge is accurately aligned with the beginning of each UTC (Coordinated Universal Time) second on the GSP System Master Clock. It is advantageous to measure these signal characteristics for many broadcast control channel signals simultaneously, for example, for up to 16 signals. Signals from a number of base stations can thus be measured and analyzed relative to the reference time-frame provided by the GPS system. The broadcast control channel may be in a GSM system a BCCH channel. To separate BCCH channels originating from more than one base station or from more than one sector of base stations from each other, the BCCH channels may need to be in different frequencies or to have a large attenuation and also different training sequences. A training sequence is a subset of the Base Station Identification Code (BSIC) code.

The network survey device 200 with GSM and GPS receivers 210, 220 integrated therein is a very applicable tool for network survey in an existing GSM system or in any other radio telecommunications system when the device 200 is provided with a suitable receiver 210. The network survey device 200 can be used to record the selected GSM signal bit error rate (BER), level and signal timing with exact position data on a map.

It should be appreciated that by placing the network survey device 200 equipped with E-OTD and AGPS functionality at a fixed position in the GSM network, the network survey device may be used as a GSM Location Measurement Unit (LMU).

The network survey device 200 is compact in size (typically less than 450 cm³) as the basic hardware contains only a GSM receiver 210 and a GPS receiver 220 and a control unit 230 for controlling these receivers jointly. The integrated hardware and joint control allows an excellent timing accuracy, which can be around 100 ns.

The network survey device may have double flash memory, which allows changing the network survey device software functions relatively fast and easy for different purposes.

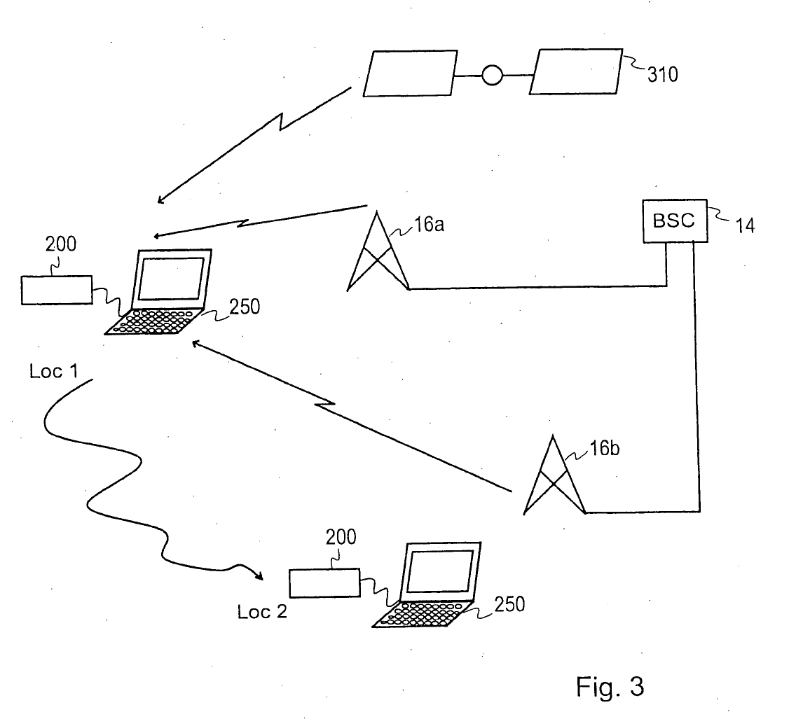

FIG. 3 shows an example of using the network survey device 200 in accordance with the first embodiment. The network survey device 200 is moved around the target area of the network survey. FIG. 3 illustrates specifically two locations (LOC1 and LOC2) for the network survey device 200. The network survey device 200 receives signals from at least one base station of the radio telecommunications network and also from an external location system. FIG. 3 illustrates this external location system as the satellite 310.

The network survey device 200 may be connected to a computer 250, for example to a laptop computer. The computer 250 is equipped with network survey software for controlling the network survey device and for displaying the measurement results. The measurement results to be displayed typically include time and frequency domain presentations connected to a digital map including height information.

The computer 250 may further be equipped with a network planning software. Alternatively, it is possible to transfer the measurement results from the network survey device 200 or from the computer 250 to a further computer equipped with the network planning software. The collected measurement data can be analyzed in the network planning software offline from a file, or the collected measurement data may be delivered alive with a Personal Computer Memory Card International Association (PCMCIA) GSM modem from the computer 250 to a further computer. The collected data can be delivered in various forms, for example XML-file is suitable for offline analyzing with the certain network planning applications.

As an alternative to connecting the network survey device 200 to a computer 250, it could be connected to BTS similarly as a B-type LMU in fixed installation.

As the location of the network survey device 200 can be determined and recorded, it is possible to record measurement results with location information and to view and/or analyze the measurement results with the help of a map.

In addition to omni-directional antenna, a directional GSM antenna for interference direction scanning would complement the system including the network survey device 200 and the computer 250 equipped with network survey software, especially if the direction would be controlled and recorded by the network survey software. As a way of implementing advanced troubleshooting of the network, the network planning software could propose changes to the network configuration data to achieve better functionality. Conflicting frequency, timeslot synchronization, power setup, and/or BCCH&BSIC codes can be easily recognized and fixed.

The network survey device 200 and the computer 250 may be fitted into a survey car. The power for the network survey device may be supplied, for example, by a cigarette lighter, similarly as for other electronic devices. The GPS antenna and GSM antenna may be fitted to the roof of the survey car. Survey data can be analyzed locally by the network survey application or later with some network planning application.

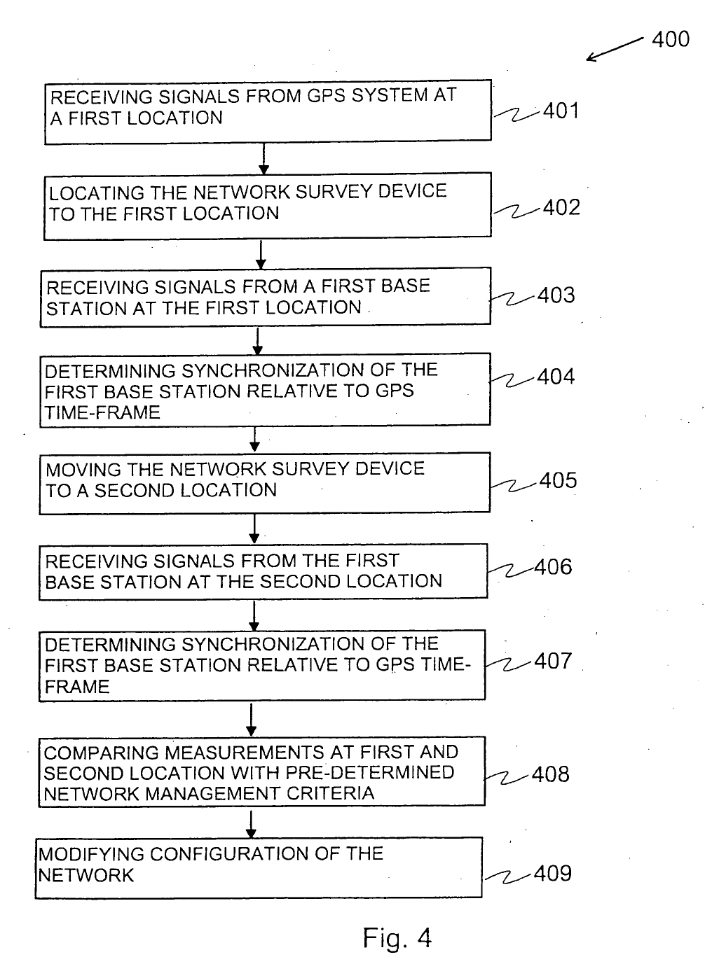

FIG. 4 shows a flowchart of a method 400 in accordance with a second embodiment of the invention. In step 401, the network survey device 200 is in a first position and it receives signals from the GPS system with the GPS receiver 220. In step 402, the network survey device 200 locates itself at the first location. In step 403, the network survey device 200 at the first location receives signals from at least one base station (a first base station) of a GSM network. In step 404, the network survey device 200 determines the synchronization of the first base station relative to a reference time-frame determined from the GPS system.

In step 405, the network survey device 200 is moved to a second location. In step 406, the network survey device 200 at the second location receives signals from at least the first base station and typically also from neighboring base stations of the same telecommunications network or from another set of base stations belonging to a second telecommunications network. The second telecommunications network is typically operated by a different network operator. The network survey device 200 may additionally measure signals from further base stations at the second location or at both the first and at the second location. In step 407, the network survey device 200 determines again the synchronization of the first base station relative to the reference time-frame determined from the GPS system.

In step 408, the results of the measurements of the first and second locations are compared with pre-determined network management criteria. In step 409, the network configuration is modified based upon the result of the comparison. Conflicting frequency, timeslot synchronization, power setup, and/or BCCH&BSIC codes can be easily compared to network planning information and fixed if necessary. The steps 408 and 409 are typically carried out with a network planning software. Modifying the configuration of the network may require further in situ modification of the physical equipment.

When the network survey device 200 supports E-OTD, synchronization and AGPS, it is thus capable for recording critical information for each of the systems. As all relevant measurement information is recorded at the same time with a single piece of equipment high measurement accuracy can be achieved.

As an example of using the network survey device 200 for network planning, it is possible to direct or adjust the position of the antennas of base stations so that the accuracy of the positioning methods or mobile service quality is improved.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A method of performing a network survey for a radio telecommunications network comprising two or more base stations, the method comprising:
receiving signals from a location system external to a network for determining a location of a network survey device;
locating the network survey device at a first location and, with the network survey device at the first location, receiving signals from a first base station of the network at the first location by means of the network survey device, thereby measuring synchronization of said first base station relative to a reference time-frame determined from the location system; and
moving the network survey device to a second location and, with the network survey device at the second location, receiving signals from the first base station at the second location by the means of a network survey device, thereby measuring synchronization of said first base station relative to the reference time-frame.

2. A method as recited in claim 1, further comprising the step of comparing results of measurements at the first and second locations with pre-determined network management criteria.

3. A method as recited in claim 2, further comprising the step of modifying a configuration of the network based upon the results of the comparison.

4. A method as recited in claim 1, wherein the receiving step comprises receiving the signals from the location system, which comprises a satellite location system and the signals from satellites of the system are received for determining the location of the network survey device.

5. A method as recited in claim 4, wherein the receiving step comprises receiving the signals from the location system, which comprises the Global Positioning System.

6. A method as recited in claim 4, further comprising:
recording visibility of the satellites and quality of the signals of the satellites by means of the network survey device.

7. A method as recited in claim 1, further comprising:
measuring a quality and a signal level of the signal received from the first base station.

8. A method as recited in claim 1, further comprising:
receiving signals from a second base station of the network by means of the network survey device in the first and second locations, and
synchronizing the second base station relative to the reference time-frame.

9. A network survey device comprising:
first receiving means for receiving signals from base stations;
second receiving means for receiving a reference time-frame signal; and
first measuring means for measuring synchronization of base stations relative to a reference time-frame.

10. A network survey device as recited in claim 9, further comprising second measuring means for measuring the synchronization of at least one base station relative to another base station.

11. A network survey device comprising:
a first receiver for receiving from signals from base stations;
a second receiver for receiving a reference time-frame signal; and
a measuring device for measuring synchronization of a base station relative to a reference time-frame.

12. A method of obtaining network survey information in a telecommunications network comprising a plurality of base stations, the method comprising the steps of:
receiving signals from a location system external to a network for determining a location of a network survey device;
locating the network survey device at a first location and, with the network survey device at the first location, receiving signals from at least one of a plurality of base stations at the first location by means of the network survey device, thereby measuring synchronization of said at least one base station of said plurality of base stations relative to a reference time-frame determined from the location system; and
moving the network survey device to a second location and, with the network survey device at the second location, receiving signals from said at least one base station of said plurality of base stations at the second location by the means of a network survey device, thereby measuring synchronization of said at least one base station of said plurality of base stations relative to the reference time-frame.

13. A method as recited in claim 12, further comprising the step of comparing results of measurements at the first and second locations with pre-determined network management criteria.

14. A method as recited in claim 13, further comprising the step of modifying a configuration of the network based upon the results of the comparison.

15. A method as recited in claim 12, wherein
the step of locating the network survey device at the first location comprises receiving the signals from said plurality of base stations, and
the step of moving the network survey device to the second location comprises receiving the signals from said plurality of base stations.

16. A method as recited in claim 12, wherein the step of moving the network device to the second location comprises receiving the signals from a first base station and from at least one neighboring base station of the network.

17. A method as recited in claim 12, wherein the step of moving the network device to the second location comprises receiving the signals from a first base station of the network and at least one base station associated with another telecommunications network.
